(19) United States
(12) Patent Application Publication
(10) Pub. No.: US 2005/0177444 A1
(43) Pub. Date: Aug. 11, 2005

(54) Service center and associated method for offering services in a retail environment

(76) Inventor: Richard M. Davies, Charlotte, NC (US)

Correspondence Address: SUMMA & ALLAN, P.A., 11610 NORTH COMMUNITY HOUSE ROAD, SUITE 200, CHARLOTTE, NC, 28277, US

(21) Appl. No.: 10/772,711

(22) Filed: Feb. 5, 2004

(51) Int. Cl. G06F 17/60

(52) U.S. Cl. 705/26

(57) ABSTRACT

The invention is a service center and a method of providing services within a retail environment that would traditionally not accommodate such services. The method of the invention separates the location of the marketing and sales activity from the location of providing the actual services. Pursuant to the disclosure herein, customers bring a serviceable item to a retail facility and give the service provider temporary possession of the item. The service provider moves the item to a service facility that is physically separated from the retail environment. The invention provides a means for maintaining communications between the service provider and the customer. The sales and marketing activities of the invention herein occur within an appealing retail environment at a kiosk, a storefront or other facility. The service center and the associated method are particularly adept for providing automobile services with a shopping mall environment. A customer may receive automobile services while the customer remains inside of a shopping mall. The service provider moves the automobile to a garage area possibly located within the mall parking area or even within an underground service facility.

### BACKGROUND OF THE INVENTION

The overall concept of this invention is that of accessing customers for services in a retail environment, but disconnecting the retail environment where the customers are located from an industrial environment where the services are performed. This method of providing services, along with the associated sales center for accommodating the method, connects retail customers with the service providers in an upscale environment that would ordinarily be restricted in the services that could be offered. In one respect, the invention is a method of enabling service providers to engage customers in diverse settings, where the customers choose to gather for other purposes, such as shopping or entertainment centers. The disclosed method provides a way for service providers to accommodate customers at their convenience so that the customers do not need to travel to the service provider's traditional location. Simultaneously, customers receive services in more appealing venues, most of which have been previously unavailable as sites for acquiring the services.

Providing new methods of connecting customers to certain goods or services has been a sales and marketing quest for generations. Today's economy is full of new selling techniques, particularly in light of the expanding role of computers in business transactions. Consumers often use in-store computers, such as retail kiosks, to order specific goods pursuant to specialized input data. Modem consumers are also quite accustomed to shopping on the internet from home, work, or specialized locations. Electronic transactions are becoming more prevalent as consumers have less time and opportunity to physically travel to several locations in search of a specific item or service.

While on-line or computerized shopping for goods is nothing new, the services sector presents a different scenario. Customers shopping for services often need to be physically present at the service provider's location to enable service work to be done. For example, while a person may select a hair stylist by studying information available in print ads or on the internet, it is impossible to get the haircut without going to the stylist's location or having the stylist come to the customer's location. At some point, to complete the transaction, the customer and the service provider must physically meet. Until recently, it was generally impossible to receive many services without this physical meeting between the service provider and the consumer.

Recent developments in service sales have begun to account for the fact that customers value the ability to purchase services on their own terms and without the constraints of being physically present in a traditional location. While services performed on a person's body may still require some form of physical presence for quite some time, services performed on a person's possessions do not require absolute physical unity between the customer, the item to be serviced, and the service provider.

Many customers appreciate having services performed on their possessions while they are located in a different, more appealing environment. For example, when the owner of an automobile drives a car to a garage for service, that customer generally does not sit in the actual garage to wait. The more successful garages offer plush waiting rooms with television and refreshments to help the driver pass the time in a comfortable setting. Most consumers, however, would rather have even more control over the time required to receive services on a possession such as a car.

New business methods are required to give a consumer more control over the manner of passing the time required to receive services. Likewise, modern service providers need a method of reaching out to consumers in locations that appeal to the consumer. The service sector of today's business economy achieves these goals by allowing flexibility in a customer's whereabouts during the time that the provider performs the service. Ideally, the service provider could offer services in a locale that gives the consumer opportunities to be productive, or at least entertained, while waiting for the service.

Many service businesses operate in an industrial environment because the service requires machinery, tools, and sometimes even hazardous conditions to achieve the proper result. Customers requiring services on their possessions typically avoid these locations because of the uncomfortable and possibly dangerous atmosphere. This scenario presents two problems in the service-oriented business sector. First, the service providers cannot easily attract customers or even contact customers that generally refrain from visiting the service provider's establishment. Second, when a customer has no choice but to visit the service provider's location, the experience is considered mostly a necessary evil that wastes valuable time.

The only means for remedying these problems requires separating the service marketing locations from the location of rendering the service. In this manner, the consumer can receive information about the services, select which services they need, and purchase the services in a comfortable location that gives the consumer choices for how to spend their time. Correspondingly, the service provider has total control over the location at which the actual service is rendered and can continue to use all available industrialized operations without the danger of annoying, scaring, or harming the consumer.

A search of the prior art shows developments in separating the point of purchase from the point of actually completing a business transaction. Most of the prior art in this area focuses on methods for allowing customers to purchase goods from remote locations, i.e., the site of the purchase is not in physical proximity with the desired items.

One commonly recognized method that separates the point of purchasing from the point of completing the transaction is that of purchasing tickets to movies or other events. U.S. Pat. No. 5,797,126, issued to Heibling et al. on Aug. 18, 1998, allows a customer to utilize a kiosk or other remote electronic device to scan the available selections for movies or other events at certain venues. The customer views excerpts or scenes of selected performances to gain insight into which selection is the best for that customer. The patent also allows a customer to select a certain seat and shows the view from that seat as a preview to attending the performance. The customer selects a performance, a time, and a seat before paying for admittance by credit card at the remote kiosk or terminal. The kiosk or terminal presents the customer with either a ticket or a coupon redeemable for a ticket at the remotely located venue. This separation between the point of purchase and the actual admittance to the performance allows greater flexibility for the customer to make plans from a variety of locations. The customer does not need to drive to the venue to purchase a ticket. The patented system also avoids delay in receiving tickets by mail or standing in long lines at the site of the performance.

International Patent Application WO 01/03040, filed on Jul. 3, 2000 by Jordan Klear and Marc Steren, offers further improvements to the typical remote ticket purchasing systems. The Klear '040 patent application seeks patent protection for a method of allowing a customer to purchase admittance to an event from remote locations via a data communications network. Instead of redeeming a coupon or presenting a ticket at the actual venue, the data network identifies the customer by a number such as a credit card number, a cell phone number, or a special pass card number. When the customer arrives at the event, the network recognizes the customer as having prepaid admittance when the customer presents the identifying number at the point of entry. The identification process may be as simple as having possession of a certain card or even the cell phone by which the customer ordered and prepaid admittance. This patent application is another example of purchasing admittance remotely and offers an improved method of identifying and admitting the proper consumer at the physical location of the event.

Competition for consumers has led retailers and other merchants to create innovative means for connecting shoppers to desired goods and services. Many shoppers want convenient access to the marketplace but would rather avoid being physically present in a shop or a store. A series of relatively recent United States patent applications shows progress in the realm of separating a shopper's point of purchase from the actual delivery of the goods to the consumer. On Apr. 3, 2001, Anthony Pugliese et al. filed patent application No. 2001/0044751 for a System and Method for Displaying and Selling Goods and Services. Pugliese '751 presents the ShopLive system that provides easy access to merchandise and sales assistance through various portals. In this respect, the patent separates the shopping experience from the location of the vendor. The portals may be personal computers, mall kiosks, or other communication devices that connect a shopper to the merchant for a live interactive shopping experience over a network. The shopper is located remotely from the actual vendors, but the shopper maintains visual and audio contact with the selected merchants throughout the shopping session. The shopper may ask questions to a shopping assistant that may be one of the merchant's actual employees. Alternatively, the shopping assistant may be a “virtual assistant,” programmed to be knowledgeable of the merchant's wares. The system uses video cameras throughout each merchant's location to provide the necessary images that enable a shopper to make intelligent choices. At the end of the shopping mission, the shopper can either physically pick up the selections or arrange shipping.

Remotely shopping for goods is also the subject of U.S. patent application No. 2002/0026380 filed by Su et al. on Aug. 10, 2001. Su improves upon other shopping systems by claiming an arrangement that includes an e-shopping area within a traditional shopping mall. According to Su '380, a shopper goes to the mall and has two shopping choices. In the first method, the shopper may shop by walking through all of the selected stores. In the second method, the shopper may access all of the stores in the physical mall via the e-shopping hall. The e-shopping hall has a variety of electronic portals or kiosks available to browse merchandise from each vendor in the mall. The customer can select items for purchase by viewing the available merchandise on the local electronic database for that mall. The e-shopping hall may be located within the mall or elsewhere. If the e-shopping hall is located within the shopping mall, the customer's selected items from each store may be delivered to that hall for the customer to carry home. Su once again shows the convenience of allowing a customer to buy goods without physically visiting the individual store. Su also shows that many customers enjoy going to the mall but cannot or do not wish to walk the distances required to shop in the entire mall. Su provides a means for customers to shop the entire mall while being physically present in only a small portion of the mall, if any.

In terms of shopping for goods, U.S. patent No. 2003/0154135, filed by Covington et al. on Dec. 19, 2001, shows a further separation between the point of selecting an item and the ultimate purchase of that item. In fact, Covington makes note of the fact that, in some instances, the person who selects the item is not the same person as the one who ultimately purchases that item. In this regard, Covington shows a system for separating not only the point of selecting and the point of purchasing but also allows for different individuals to participate in each part of the ultimate transaction. Covington shows an interactive system that uses an in-store/in-mall computer system and a plurality of hand-held scanners configured to scan product information and upload that information to a central database. The system allows a user to scan items for a wish list at participating stores before or after creating an account with the system. The system then allows other purchasers to buy these selected items as gifts for the one who selected them.

These prior approaches to providing consumers some choice in shopping methods generally center around shoppers seeking access to goods. Recent business developments, however, recognize that many consumers also require diversity in the methods available for procuring services. Traditionally, obtaining any type of service has mandated a physical meeting between the consumer and the service provider. As consumers have become busier, and time for acquiring services more scarce, the marketplace has seen exponential growth in the ability of services providers to reach customers in a wider variety of venues.

One example of obtaining services in a nontraditional location is readily evident in the field of banking. For generations, all banking business occurred in the bank itself. Every transaction, from complicated loans to simple check cashing, required a visit to the local bank. Eventually automatic teller machines provided some banking services outside the normal bank building. Today, bank customers can transact almost every type of financial business via a computer from any location in the world. International Patent Application WO 99/08215, filed by Coutinho et al. on Aug. 4, 1998, is an example of a method of servicing bank customers from distant locations. Coutinho '215 relates to a banking facility layout in which the customers contact a banking representative via telecommunication links. With the proper telecommunications infrastructure, a consumer can receive the assistance of bank employees just as if the consumer walked into the bank. Of course, the telecommunications allow this interaction from remote locations.

Financial services are not the only businesses within the services sector that have begun to offer consumers more choices in the method and location of transacting business. Even personal services have moved out of the traditional venues. The Proctor and Gamble Company filed International Patent Application WO 01/91600 on May 25, 2001 for a method of providing personalized cosmetics. The patent application seeks protection for a method by which a consumer visits an electronic portal, such as a kiosk, and inputs personal diagnostic data. The kiosk is connected to a broader network and allows the customer's personalized data to be evaluated by a computer program on the network at a remote location. The kiosk, or portal, is equipped to dispense personalized cosmetics that are specifically mixed to enhance the appearance of the individual that entered the data. This patent allows consumers to avoid the traditional “beauty counter” in open retail environments. The Proctor and Gamble method does not require a physical meeting between the consumer and the service provider, even though cosmetic consultations are often quite personal.

The travel business is a final area to consider in analyzing new methods of connecting a consumer to a service provider. On Nov. 5, 1966, Steven Horowitz filed International Patent Application WO 98/19581 for an open but secure travel kiosk. The patent application seeks patent protection for a full service travel business that may be located in commercial public areas such as shopping malls. The counters of the kiosk may contain transparent areas that show computers with travel information on the screen. Consumers shopping at the mall may stop at the kiosk, study the available travel options, and purchase all of their travel services at the mall. The kiosk is equipped to provide tickets, currency, and literature for the consumers on the spot, or the consumer may connect to a larger, more traditional travel center from the kiosk. In any event, Horowitz '581 brings a travel center into a commercial retail setting to tap into the customer base already shopping in the mall. Likewise, consumers conveniently arrange travel plans without making extra trips to a traditional office for a travel agent.

The discussion above shows advances in the marketplace for bringing products and services to locations where consumers are more likely to convene. Competition in every business sector has led retailers and service providers to make more concerted efforts to reach consumers in the consumers' chosen environments. A need still exists, however, for a method of reaching consumers seeking services that cannot be provided in the exact location where the consumers typically assemble. Consumers may need work on their possessions, such as cars, equipment, or even their homes, that are not readily transported inside a mall or other open area where the consumer tends to go.

One service area that is universally sought by consumers but too often limited in venues is that of automobile repair. Even the expansion of computer services has yet to solve the dilemma of a consumer when the time comes to repair the car. Mostly, the choices are dropping off a vehicle for some time to be repaired or driving to the repair shop and waiting for extended periods. Either option is a poor choice because the driver will be inconvenienced. Many automobile owners would prefer a more personalized approach that allows the consumer to have repairs completed while the consumer is actively engaged in a more productive activity. Significantly, some retailers have combined auto shops with large scale retail stores. Consumers drop off their car in one part of the store and spend time in browsing the remainder of the store. Sears® and WalMart® are two examples of this technique. Walmart has gone so far as to automate some of the repair processes, such as tire selection, by offering computerized kiosks to aid in the service selection. The main drawback of these retail alternatives is that the consumer is generally exposed to the industrial garage atmosphere during the repair, and the customer is also limited to one store that may not offer the products or services that the consumer needs at that time.

### SUMMARY OF THE INVENTION

The invention herein is a method of providing services to a consumer in an appealing environment that has previously been unavailable as a location for obtaining the desired services. In one embodiment, the method recites that a customer may bring an item to a preferred location to obtain services for that item. The method further allows consumers to obtain required services at locations that offer consumers options for spending the time required for the service provider to complete the work. By the method of this invention, the consumer can receive services in a preferred location, even if the item to be serviced does not traditionally conform to such a location due to the size of the item or the nature of the service to be rendered.

The method accomplishes its goals by separating the point of purchasing the service from the point of actually rendering the service. In this fashion, the customer can conveniently arrange for a service to be performed on a particular item while the customer is in an appealing environment. The service provider performs the desired service at a remote location, separated from the appealing environment in which the customer remains. The claimed method includes a step of continuously updating the customer of activities performed on that customer's item. In fact, in practicing the method claimed herein, the customer remains in communication with the remotely located service provider to accommodate consultations as necessary. If necessary the service provider may provide the customer with a hand held contact device, such as a cell phone, a pager, or a personal digital assistant.

In a more specific embodiment, the claimed method relates to repairing an automobile while the owner of the car shops or enjoys other activities in an appealing retail atmosphere. The method separates the point of purchasing the automobile repair services from the location where the service provider performs the work. Pursuant to the method herein, the customer drives to a convenient and pleasant retail environment, such as an up-scale shopping mall. While inside the mall, the customer selects and purchases automobile repair services. The automobile service provider provides customer services and marketing activities inside the mall but completes the service work at a separate location outside the retail environment. The owner of the car avoids any exposure to the industrial garage work necessary to complete the desired automobile repairs. Customers avoid the repair shop atmosphere, but the method herein includes a step of ensuring communication between the customer and the remotely located service provider. The customer enjoys the features of a fun retail area, has necessary repair work conducted on the automobile, while remaining apprised of every aspect of the service work.

### BRIEF DESCRIPTION OF THE DRAWINGS

FIG. 1 is a perspective view of a consumer retail facility according to the present invention.

FIG. 2 is a front elevational view of the consumer retail facility of FIG. 1.

FIG. 3 is a rear elevational view of the retail facility of FIG. 1.

FIG. 4 is a top plan view of the retail facility of FIG. 1.

FIG. 5 is a cross-sectional view of aspects of a service facility according to the claimed invention.

FIG. 6 is a top plan view taken along lines 6-6 of FIG. 5.

FIG. 7 is a cross-sectional view of another embodiment of a service facility according to the present invention.

FIG. 8 is a front elevational view of a monitor and a displayed image according to the present invention.

FIG. 9 is a perspective view of a personal digital assistant carrying an image according to the present invention.

FIG. 10 is a perspective view of a cellular phone displaying an image according to the present invention.

FIG. 11 is a perspective view of a pager used in accordance with the present invention.

FIG. 12 is a flowchart showing the order of operations for the present invention.

### DETAILED DESCRIPTION

In one aspect the invention is a service center for offering short turnaround services on particular serviceable items in an environment in which the services could not otherwise be performed on those items. In a particular embodiment, the service center offers short-term services on automobiles in an environment that has been traditionally unavailable for automobile services. The size of the automobile and the nature of the services has limited the environments in which one can receive automobile services. The terms “short turnaround” and “short-term” services include, but are not limited to, those services for which the customer generally waits for completion, i.e. services that require giving up possession of the item for up to several hours, as opposed to giving up possession of the item for several days.

As used herein, the term “serviceable item” is used to describe a physical item upon which the services are performed. Stated differently, the services at issue for purposes of this invention are not personal services that are delivered to the customer themselves, such has hairstyling, application of cosmetics, personal tailoring, or other activities requiring the personal presence of the customer. Instead, as used herein, “serviceable items” are those that, in most or all circumstances, must be taken into the possession or custody of the service provider for the service to be carried out. In this regard, the presence of the customer at the service facility is not required in order to fulfill the service.

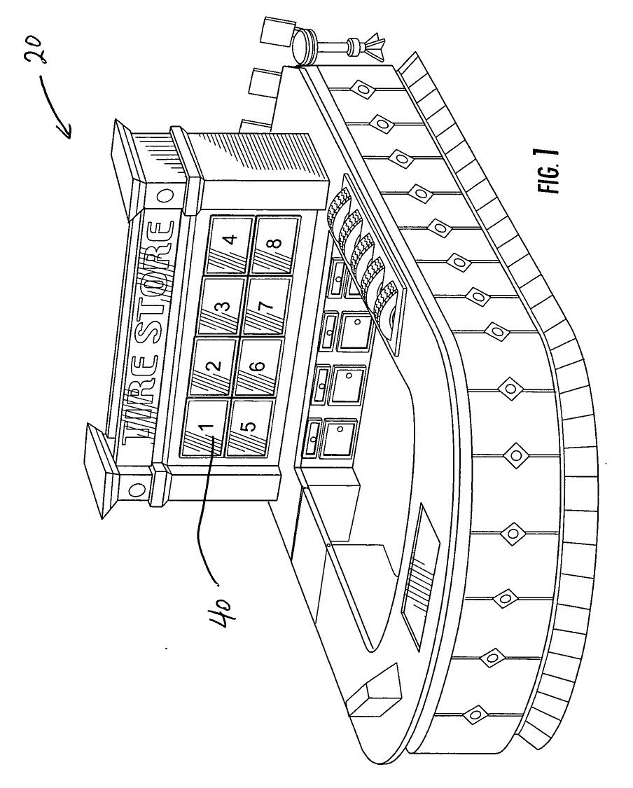

The service center of this invention includes a consumer retail facility broadly designated at 20 in FIG. 1. The retail facility 20 is equipped to provide access to customers seeking services on serviceable items. As illustrated in FIG. 1, the retail facility is in the form of a counter, kiosk, or storefront that is most preferably positioned on the inside of a retail mall. In a most preferable embodiment, the retail facility, also known as an “indoor facility” as claimed herein, is located in an enclosed mall where customers browse inside.

As set forth in the background, in many circumstances, malls have a collection of retailers that attract diverse customers, including affluent customers desiring individual attention regarding a wide range of products and services. The invention disclosed herein provides a service center that allows the mall customers to procure services at the retail facility 20. Likewise, the invention provides the opportunity for the service provider to offer services in an environment where the services themselves cannot otherwise be performed. As used herein, the invention generally applies to the retail facility, as described above, being located in a broad “retail environment.” Without limiting the applicability of the invention, a “retail environment” is a place, or enclosed area, in which at least several retail merchants run stores or offer goods for sale.

Stated more directly, the interior of the retail mall is generally unsuitable for automobile service work, and, indeed, the value of the square footage in a retail mall would make such services prohibitively expensive. Nevertheless, almost every customer that visits a mall uses their automobile to do so. Automobile services, therefore, are a logical extension of the goods and services available at a mall.

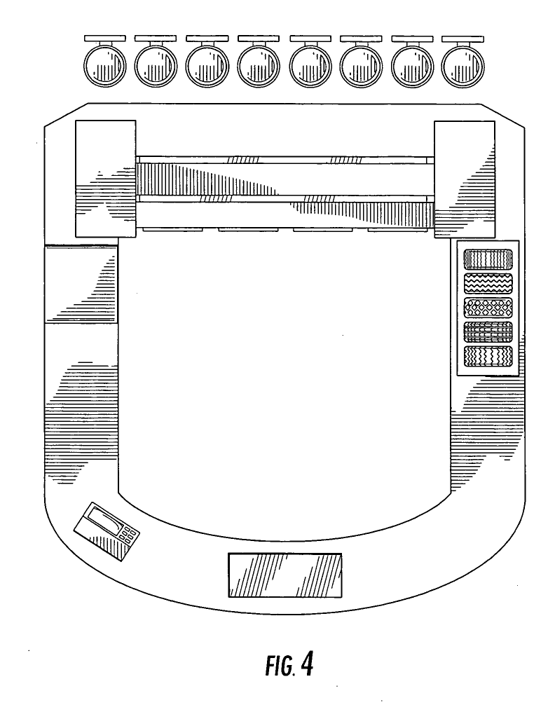

It will be understood that the retail facility illustrated in FIGS. 1 through 4 is illustrative rather than limiting of the invention and of the retail facility.

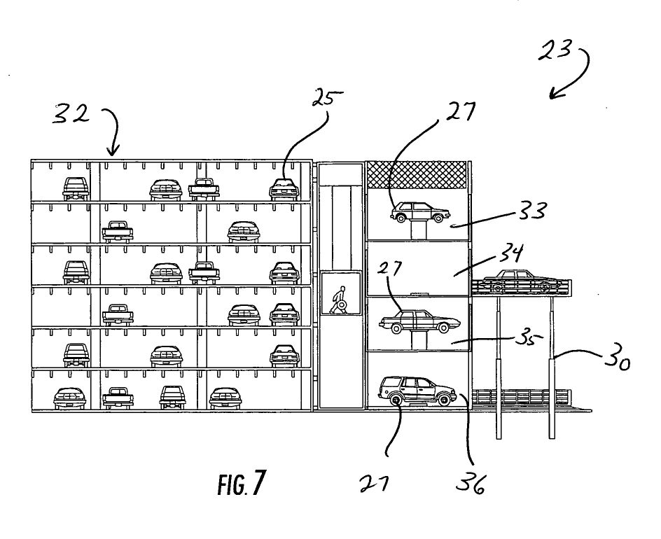

FIGS. 5, 6, and 7 illustrate that the service center also includes a remote service facility broadly designated at 22 in FIGS. 5 and 6 and 23 in FIG. 7 in the illustrated embodiments, the remote service facility is an automobile service facility which can carry out various automobile services or which can be used to provide replacement parts, with tires being exemplary, on a customer's automobile. In a broadest sense, however, the customers' items are considered to be movable serviceable items that cannot otherwise be serviced at the retail facility. In particular, the service facility 22 or 23 is external to and physically separate from the consumer retail facility. Thus, the invention differentiates from conventional repair, and particularly automobile repair, facilities in which the retail portion and the service portion are immediately adjacent or attached to one another.

When the retail facility 20 is located inside of a shopping mall, the service facility 22, 23 is preferably located near the retail mall but separate from the mall. Several factors come into consideration. First, many of the retailers at a shopping mall, particularly the major or “anchor” tenants have leasing agreements under which the view of their particular stores may not be impeded by other structures on the mall property. Accordingly, the service facility is preferably located at a distance far enough from the mall to avoid obstructing such visibility. At the same time, however, the method of the invention includes the steps of driving a customer's automobile from its location near the shopping mall to the remote service facility 22, 23. It is preferable, therefore, to avoid an excessive driving distance which would statistically increase the likelihood of accidental damage or unexpected events occurring while the customer's automobile is in possession of the service provider.

Accordingly, in the most preferred embodiments, the remote service facility is located on the mall property, but within or adjacent to the parking lot or, in some cases, the parking deck of the mall. Thus, FIG. 5 illustrates a parking deck, the floor of which is indicated at 24, upon which are located a number of parked cars 25. The service facility is positioned partially or totally underground and includes its own floor 26 and a number of cars being serviced 27. In order to move automobiles being serviced into and out of the service facility 22, an arrangement such as is illustrated in FIG. 5 can include one or more elevators 30 and 31.

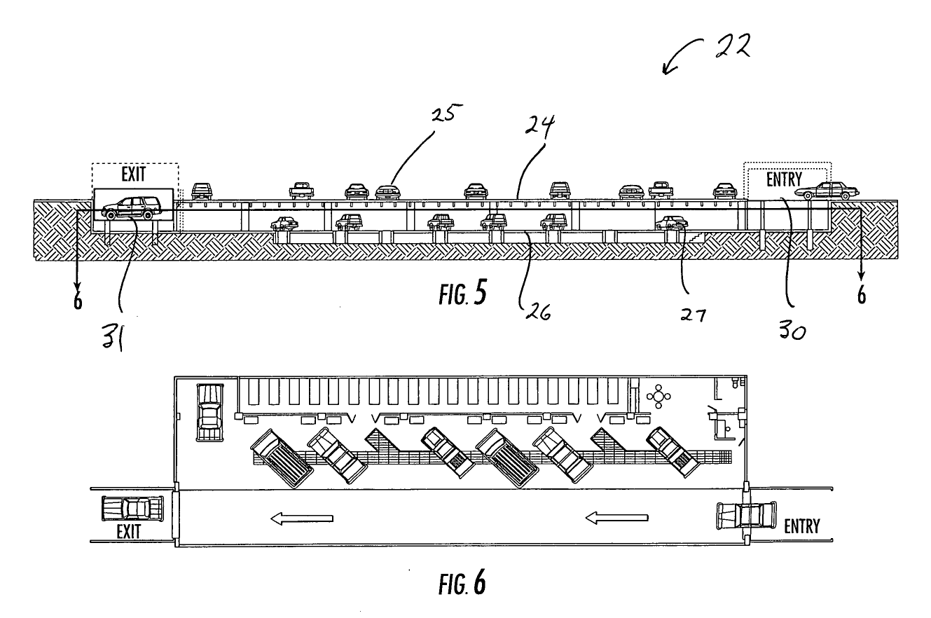

FIG. 7 illustrates an alternative arrangement in which the parking deck is generally designated at 32 and likewise includes a plurality of cars 25 that are simply positioned in the deck so that their owners can shop. The service facility 23 is illustrated as being adjacent to the parking deck 32 and illustrates four service bays 33, 34, 35, and 36 in which automobiles 27 are being serviced. As in the embodiment illustrated in FIGS. 5 and 6, an elevator 30 is used to move cars to the vertically stacked service bays. FIG. 7 illustrates an embodiment in which a vertically oriented parking deck can be incorporated with the present invention (or vice versa).

The remote service facility includes service capabilities, illustrated as the various bays just described for the customers' movable serviceable items, such as their automobiles, and also includes imaging facilities for periodic imaging of the movable serviceable items at the remote service facility on at least a near real-time basis.

Although not illustrated in FIGS. 5, 6, or 7, because of the scale of the drawings, the imaging facilities include cameras, one or more of which are preferably located in each bay, e.g., 33-36. The service center thus includes a connection, at least portions of which are electronic, for transmitting the periodic images from the remote service facility 22, 23 to the retail facility. In preferred embodiments, the service center further comprises means for transmitting the periodic images from the remote service center 22 and 23 to a customer, possibly while the customer is remote from both the retail facility 20, and the service facility 22, 23.

The retail facility includes the displays 40, preferably a plurality of monitors as illustrated in FIGS. 1 through 3, for showing the periodic images received from the service facility 22 and 23. The images are provided on or at least near the real-time basis at which the imaging facility provides the images, so that the remotely provided services can be monitored at the retail facility 20.

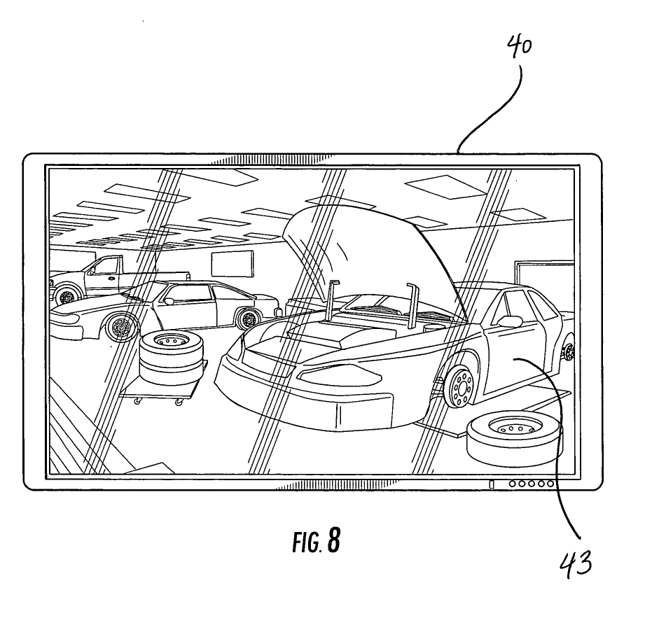

Accordingly, FIGS. 1, 2, and 3 illustrate that customers 41, 42, if they so desire, observe the images from the service facility 22, 23 while they remain at the retail facility 20. In particular, the service center 22, 23 includes a means for associating the images from the remote facility 22, 23 with a designated customer, 41, 42 so that the customer receives an image substantially limited to the customers' serviceable item. This is illustrated in FIG. 8 in which a display 40, preferably of the large, high-definition flat screen variety (although any other display will serve an equivalent function) illustrates a portion of the remote service facility with an automobile 43 being serviced. The result is that the invention provides the customer with the opportunity to have any near real-time, or preferably a continuous real-time, image of the work being performed on their automobile, as if they were present with the automobile in person.

Generally speaking, it is understood that in most circumstances consumers prefer this high level of visibility when items such as their automobile are being serviced. Such is, of course, the reason why a number of conventional service facilities include waiting areas that are immediately adjacent to service areas with windows in between. As noted above, such facilities are incompatible with the retail mall, however, and thus the invention provides the opportunity to provide the customer with a view of their automobile as they desire, while keeping the retail facility in the mall and the service facility separate from the mall.

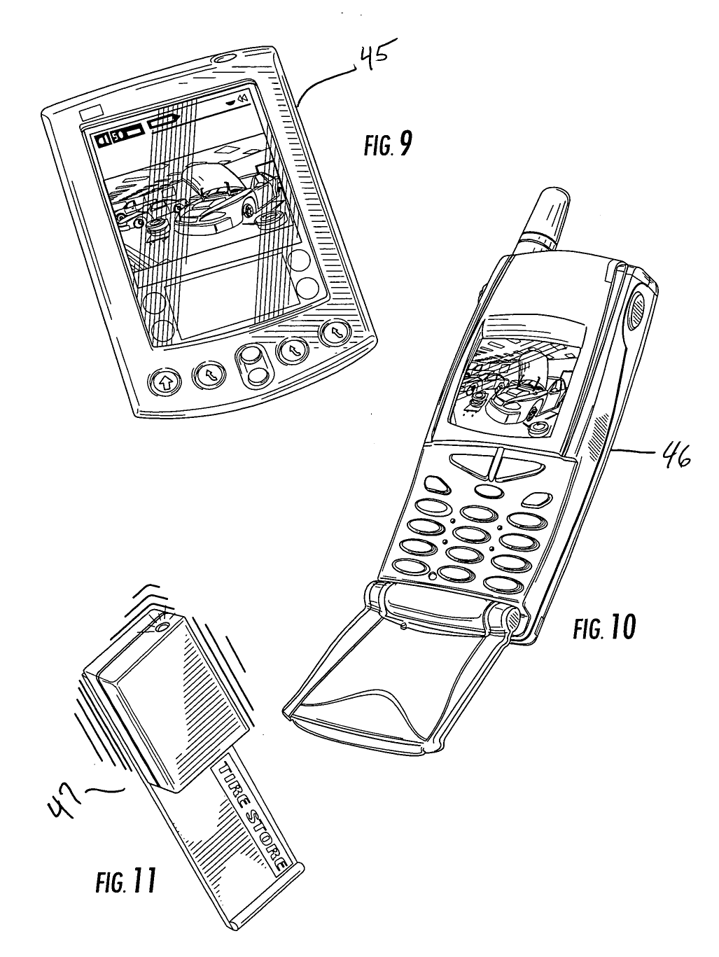

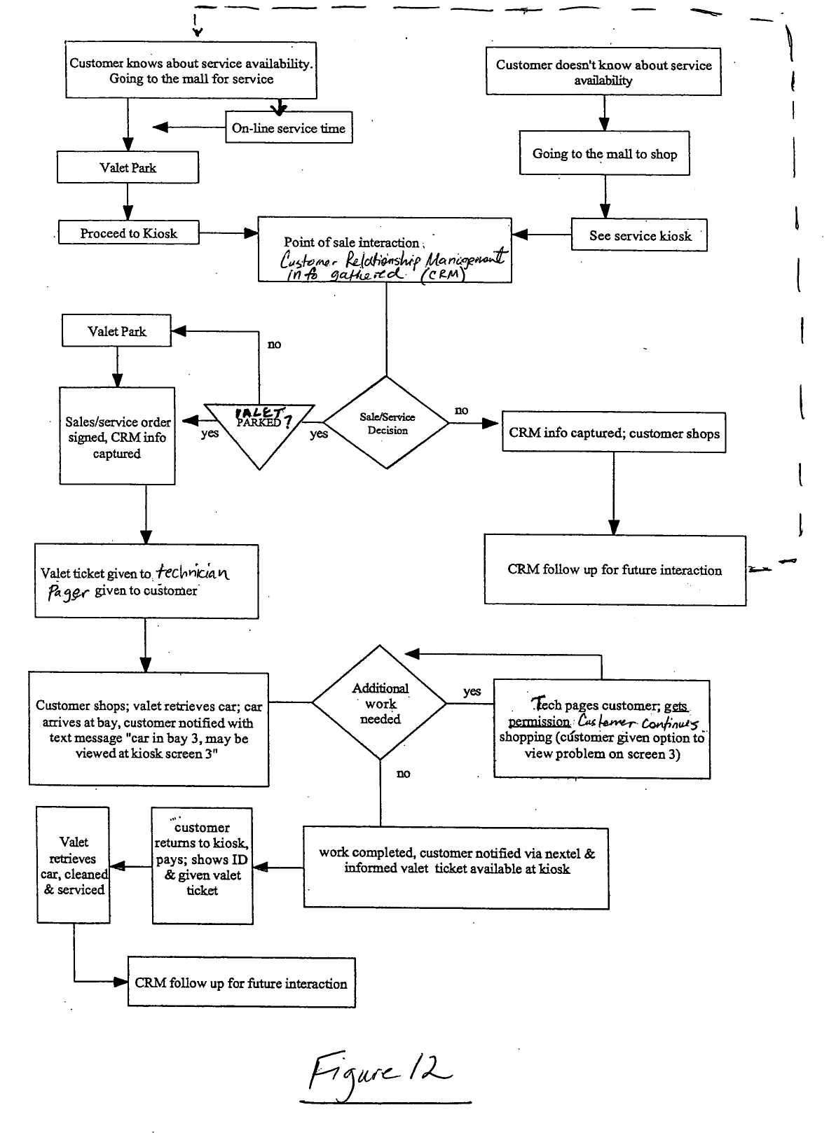

In the more preferred embodiments, the service center includes means for notifying a customer about the services at the remote service facility. The invention comprises a means for generating an electronic signal for this purpose, and FIGS. 9, 10 and 11 illustrate that both the notification, and potentially the image, can be forwarded to a customer. An image of the serviceable item may be transmitted to a customer display. As used herein, the term “customer display” generally refers to, but is not limited to a display or display unit that the customer possesses or carries. Examples of such customer displays and display units include a personal digital assistant 45 (FIG. 9), a cellular phone 46 (FIG. 10), or a personal computer. In order to simply alert the customer that the service facility needs to communicate with the customer, the method herein also encompasses the use of a type of pager (FIG. 11) that is commonly used at restaurants to notify the customer the table is ready. Once the pager is activated, the customer can call the service provider to establish communications.

Those familiar with electronic indications will recognize that the task of providing the customer with a notification or an image can be carried out by any one or more of these methods and, in particular, combinations of these messages. Thus, personal digital assistants are often capable of receiving electronic mail or the equivalent of phone calls. Similarly, cellular phones are capable of internet browsing. Additionally, with the growth and advance of wireless networking, the method can even include an e-mail message forwarded to the customer while the customer is using a personal computer. The growth of wireless hotspots in commercial establishments (coffeehouses) makes this option just as viable in many cases as the pager, personal digital assistant, or cellular phone.

Accordingly, the invention provides the opportunity for the customer to remain within the shopping mall while the customers' automobile or other item is being serviced at the remote service facility. Preferably, the imaging and connection capabilities provide the customer with the capability of demanding the images from the service center or initiating the transmission of the images from the retail facility or from the service facility. Technology is readily available for a customer to have the ability to make an electronic demand for the image by dialing a certain number on a cell phone, logging into a website, or other known means for requesting an image using computerized technology.

Additionally, because automobile repair can sometimes include situations in which additional services are required, above and beyond those initially requested or expected by the customer, the invention can include notifying the customer prior to completion of the services, showing the customer an image of items needing to be replaced or work needing to be done, and then securing the customer's authorization for such services. In the simplest circumstances, of course, the customer can simply order the service, for example a new set of tires, at the retail center 20, and then simply receive notification once the services have been completed.

One of the advantages of placing the retail facility 20 in a shopping mall is the shorter term or impulse purchase possibility from customers who are initially unaware of the presence of the service center or who, even if aware, may not have initially planned on service and visited the mall for another reason.

Nevertheless, the invention also offers the possibility for the customer, knowing that service is required, particularly automobile service, to schedule the service to coincide with a desired visit to the mall for other shopping purposes. Thus, the invention also includes the steps of the customer contacting the retail center in advance and bringing their automobile to the mall for the purpose of having it serviced while they shop and wait for the service to be carried out.

Accordingly, in another aspect, the invention is a method of servicing items from a retail environment at which the services cannot otherwise be performed. In this embodiment, the invention comprises accepting a purchase order from a customer, while the customer is present at a retail facility, for services on movable serviceable items that cannot be physically performed in the retail environment. In the more specific embodiment, this comprises accepting the purchase order from a customer while the customer is inside a shopping mall for services on the customer's automobile that cannot be physically performed in the high retail environment of the mall.

In this aspect, the invention comprises moving the customer's serviceable item to a service facility external to and physically separate from the retail facility. In particular, for automobile service, the step of moving the customer's automobile comprises driving the automobile from the mall parking lot to the remote service facility for or on behalf of the customer. This is even the same as or directly analogous to a valet parking system. Indeed some malls provide this service for their customers already. In such cases, the retail centers use valet parking that can be directly combined with that offered by the mall so that a customer arriving at the mall can start by dropping their car with valet parking, and then informing the retail center that the car has been valet parked when the customer places the purchase order.

In this embodiment, the method further comprises periodically, and preferably continuously, imaging the serviceable item at the service facility on or at least near the real-time basis by which the service facility transmits the image of the serviceable item to the retail facility. The serviceable item is then serviced at the retail facility during the periodic imaging so that the image of the item and the service being performed are available all on the near real-time basis, preferably continuously, at the retail facility.

The method includes the step of notifying the customer about the service on the customer's item and then returning the serviceable item to the customer from the service facility.

In a manner analogous to the description of the product aspects of the invention, the step of transmitting the images can comprise posting the images on a display at the retail facility or transmitting the images to the customer while the customer is remote from both the retail facility and from the service facility. Thus the step of transmitting the images can comprise transmitting the image to a video monitor at the retail facility at which the purchase order was accepted or transmitting the images to a device carried by the customer. Devices carried by the customer may be, by way of example and not limitation, a borrowed pager, a personal digital assistant, a cell phone, or even a personal computer.

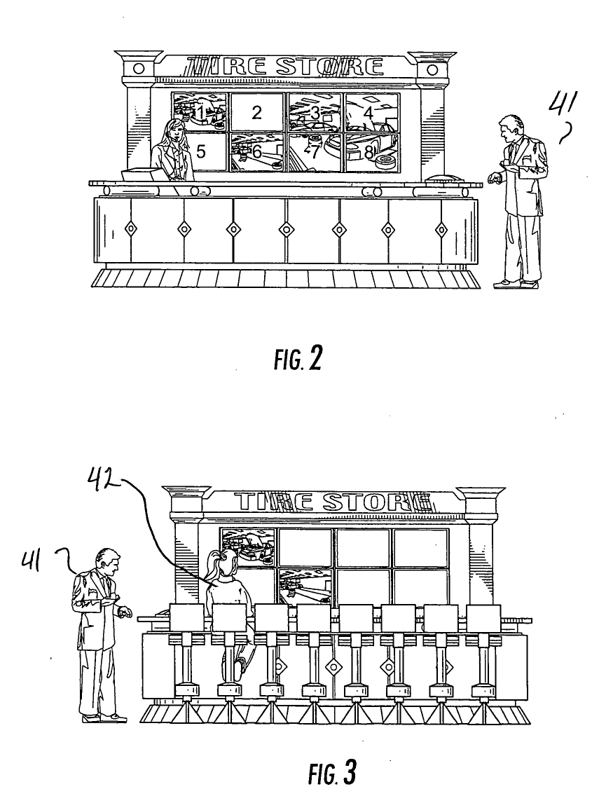

The step of transmitting the images can be carried out on demand from the customer so that the customer can, for example, evaluate the progress of services while they are shopping elsewhere in the mall. Otherwise, the step of transmitting the images can be initiated by the service center, for example to seek the customer's permission to carry out further work. Also, the images can be transmitted from the retail center to the customer as may be desired or necessary. As illustrated in FIGS. 2 and 3, in one aspect, images can be posted on displays such as monitors 40 at the retail facility 20.

In the mall environment and using the valet parking step described above, the method can further comprise returning the item, particularly an automobile, to the customer at a third location, e.g., the mall entrance, other than the retail facility and other than the service facility. Thus, it will be seen that the invention provides the opportunity for the customer to drive to the mall, drop their car with valet parking, visit the retail facility and order the desired services. The customer may furthermore shop while the services are being carried out, be notified when further authorization is needed or when the services are complete, pay for the services at the retail facility, and then return to the mall entrance to have their car delivered to them at a desired time by the valet parking service.

Although the invention has been described in terms of the singular customer, it will be evident from FIGS. 1 through 3, as well as the description herein that the invention includes the capability to service a plurality of cars concurrently. The invention allow for transmitting individual images to individual customers either by transmitting them to the monitors 40 at the retail center 20, or individually to customers carrying portable customer displays.

The use of digital cameras and the electronic transmission of images in the projection of those images are all well understood in the relevant arts and will not be described in detail herein, as they can be carried out by those of ordinary skill without undue experimentation. Similarly, the degree of programming that may be required using a central processing unit or personal computer or equivalent computing capabilities (servers) is likewise well within the abilities of the skilled person and will not be otherwise discussed in detail herein.

As used herein, the term retail is used in its common sense to indicate purchases or sales made in small quantities to the ultimate or end consumer. Thus, using automobiles as an example, a retail customer is a person seeking to replace between one and four tires on a single automobile.

As used herein, the term “purchase order” is used somewhat less formally than it is used in a commercial sales transactions of a wholesale or corporate nature. Stated differently, as used herein, a customer can place a purchase order merely by visiting the retail facility and verbally requesting that the service be carried out. In many circumstances, particularly at automobile service centers, the retail facility will immediately generate and typically print at least some sort of service authorization that the customer may sign to indicate that they have agreed to a certain minimal amount of service and that no further authorization is required from the customer before the service facility can carry out the service and expect to be paid.

Imaging hardware, e.g., cameras, with communications and software connections are well understood and are now available to both the commercial purchaser and the retail purchaser from a wide variety of sources and will not otherwise be described in detail herein. The communication between the service center and the retail center and, indeed, the customer can be carried out using various hardware and software techniques, including wire signals, wireless signals, and signals carried over fiber optic lines, or combinations of any of these as may be desired or appropriate.

In the drawings and specification, there have been disclosed typical embodiments on the invention and, although specific terms have been employed, they have been used in a generic and descriptive sense only and not for purposes of limitation, the scope of the invention being set forth in the following claims.

1. A method of servicing items from a retail environment at which the services cannot otherwise be performed, the method comprising:
accepting a purchase order from a customer, while the customer is present at a retail facility, for services on movable serviceable items, wherein the services cannot be physically performed in the retail environment;
moving the customer's serviceable item to a service facility external to and physically separate from the retail facility;
periodically imaging the serviceable item at the service facility;
transmitting the image(s) of the serviceable item to a display on at least a near real time basis;
servicing the serviceable item at the service facility during the periodic imaging so that the image of the item and the service being performed are available on at least a near real-time basis at the retail facility;
notifying the customer about the service on the customer's item; and
returning the serviceable item from the service facility to the customer.

2. A method according to claim 1 comprising servicing the item while the customer engages in other activities but is available for notification from the service facility as required.

3. A method according to claim 1 wherein the step of notifying the customer comprises generating an electronic signal that at least initiates the notification to the customer.

4. A method according to claim 3 comprising notifying the customer while the customer is remote from both the retail facility and the service facility.

5. A method according to claim 3 wherein the step of generating the signal and notifying the customer is selected from the group consisting of paging a pager, calling a cellular phone; sending electronic mail, and combinations of these methods.

6. A method according to claim 1 wherein the step of imaging the serviceable item at the service facility comprises imaging the item on a continuous real-time basis.

7. A method according to claim 1 wherein the step of transmitting the images comprises posting the images on a display at the retail facility.

8. A method according to claim 1 wherein the step of transmitting the images further comprises transmitting the images to the customer while the customer is remote from both the retail facility and the service facility.

9. A method according to claim 1 wherein step of transmitting the images further comprises transmitting the images on electronic demand from customer.

10. A method according to claim 1 wherein step of transmitting the images is initiated by the service center.

11. A method according to claim 1 wherein step of transmitting the images is initiated by the retail center.

12. A method according to claim 1 wherein the step of transmitting the images comprises transmitting the images to a display unit carried by the customer.

13. A method according to claim 1 wherein step of returning the item to the customer comprises returning the item at a third location other than the retail facility and other than the service facility.

14. A method according to claim 1 wherein each step of the method is performed for a plurality of customers with a plurality of moveable serviceable items, resulting in multiple items at different stages of service, thereby requiring a plurality of imaging and notification signals communicated between the retail facility, the service facility, and the customers.

15. A method according to claim 1 wherein prior to the step of accepting a purchase order, the method includes the step of accepting a service appointment from the customer.

16. A method of providing automobile upkeep and replacement services in a retail mall environment, the method comprising:
accepting a purchase order for automobile upkeep and replacement services from a customer while the customer is present at an indoor facility inside of a retail mall;
moving the customer's automobile to a service facility external to the retail mall;
periodically imaging the customer's automobile at the service facility;
transmitting the image(s) of the customer's automobile to a display on at least a near real time basis;
servicing the automobile at the service facility during the periodic imaging;
notifying the customer about the service; and
returning the automobile from the service facility to the customer.

17. A method according to claim 16 wherein the step of moving the customer's automobile comprises driving the automobile from the mall parking lot to the remote service facility for the customer.

18. A method according to claim 16 wherein the step of moving the customer's automobile comprises driving the automobile from the mall parking lot to a remote service facility that is physically separated from the retail mall.

19. A method according to claim 16 wherein the step of moving the customer's automobile comprises transporting the automobile to a remote service facility that is located underground.

20. A method according to claim 16 wherein step of transmitting the images further comprises transmitting the images on electronic demand from customer.

21. A method according to claim 16 wherein step of transmitting the images is initiated by the service facility.

22. A method according to claim 16 wherein the step of transmitting the images is initiated by the indoor facility.

23. A method according to claim 16 wherein the step of transmitting the image(s) of the customer's automobile to the indoor facility comprises transmitting the image to a display at the indoor facility at which the purchase order was accepted.

24. A method according to claim 16 wherein the step of transmitting the image(s) of the customer's automobile to comprises transmitting the image to a display unit carried by the customer.

25. A method according to claim 16 wherein the step of notifying the customer is selected from the group consisting of paging a pager, calling a cellular phone, sending electronic mail, and combinations of these methods.

26. A method according to claim 16 wherein the step of notifying the customer comprises notifying the customer when the service is complete.

27. A method according to claim 16 wherein the step of notifying the customer comprises notifying the customer about the condition of the automobile and seeking the customer's authorization for particular services.

28. A method according to claim 16 wherein each step of the method is performed for a plurality of customers with a plurality of automobiles, resulting in multiple automobiles at different stages of service, thereby requiring a plurality of imaging and notification signals communicated between the indoor facility, the service facility, and the customer.

29. A method according to claim 16 wherein prior to the step of accepting a purchase order, the method includes the step of accepting a service appointment from the customer.

30. A service center for offering short turnaround services on particular serviceable items in an environment in which the services cannot otherwise be performed on those items, said service center comprising:
a retail facility for providing access to customers seeking services on moveable serviceable items, said retail facility lacking capabilities to provide the services therein;
a remote service facility with service capabilities for the movable serviceable items, said service facility being external to said retail facility;
imaging facilities at said service facility for periodic imaging of the movable serviceable items at said remote service facility on at least a near real-time basis;
a connection, at least portions of which are electronic, for transmitting the images from said remote service facility to a display; and
displays at said retail facility for showing images received from said service facility on at least a near real-time basis so that the remotely-provided services can be monitored at said retail facility.

31. A service center according to claim 30 wherein said retail facility is inside of an enclosed shopping mall.

32. A service center according to claim 30 wherein said remote service facility is physically removed from said retail facility.

33. A service center according to claim 30 wherein said remote service facility is underground.

34. A service center according to claim 30 further comprising a means for generating a signal notifying a customer that services have been performed at the remote service facility.

35. A service center according to claim 30 further comprising a means for transmitting the periodic images from said remote service center to a display at the retail facility.

36. A service center according to claim 30 further comprising a means for transmitting the periodic images from said remote service facility to a customer display.

37. A service center according to claim 36 wherein the customer display is selected from the group consisting of a personal digital assistant, a personal computer, or a cellular telephone.

38. A service center according to claim 30 comprising means for transmitting the images upon electronic demand from a customer.

39. A service center according to claim 30 comprising means for transmitting the images upon initiation from said retail facility.

40. A service center according to claim 30 comprising means for associating the images from said remote service facility with a designated customer so that the customer receives an image substantially limited to the customer's serviceable item.

41. A service center for offering short term services on automobiles in an environment in which the desired services cannot otherwise be performed on automobiles, said service center comprising:
a retail facility that lacks automobile service capabilities while still providing access to customers seeking services on their automobiles;
a remote automobile service facility with service capabilities for automobiles, said service facility being external to the retail facility;
imaging facilities at said service facility for at least near real-time periodic imaging of customers' automobiles while the automobiles are being serviced at said remote service facility;
a connection, at least portions of which are electronic, for transmitting periodic images from said remote service facility to displays, wherein the images show service activities being performed on the customers' automobiles; and
displays at said retail facility for showing the periodic images received from said service facility on the at least near real-time basis at which said imaging facility provides the images, so that the automobiles being serviced can be monitored at said retail facility.

42. A service center according to claim 41 wherein said retail facility is inside of an enclosed shopping mall so that a customer can remain within said mall while the customer's automobile is being serviced at the remote service facility.

43. A service center according to claim 41 wherein said service facility is in the mall parking area.

44. A service center according to claim 41 wherein said service facility is in a parking deck.

45. A service center according to claim 41 wherein the service facility is underground.

46. A service center according to claim 41 wherein said service facility includes portions underneath the mall parking area.

47. A service center according to claim 41 further comprising a means for generating an electronic signal notifying a customer that services have been performed at the remote service facility.

48. A service center according to claim 41 further comprising a means for transmitting the periodic images from said remote service center to a display at the retail facility.

49. A service center according to claim 41 further comprising a means for transmitting the periodic images from said remote service center to a customer display.

50. A service center according to claim 49 wherein the customer display is selected from the group consisting of a personal digital assistant, a personal computer, or a cellular telephone.

51. A service center according to claim 41 further comprising a means for transmitting periodic images from said remote service center to a customer while the customer is remote from both said retail facility and said service facility.

52. A service center according to claim 41 comprising a means for transmitting the images upon electronic demand from a customer.

53. A service center according to claim 41 comprising means for transmitting the images upon initiation from said retail facility.

54. A service center according to claim 41 comprising means for associating the images from said remote facility with a designated customer so that the customer receives an image substantially limited to the customer's automobile.
